(19) United States
(12) Patent Application Publication
(10) Pub. No.: US 2011/0032641 A1
(43) Pub. Date: Feb. 10, 2011

(54) MAGNETIC HEAD SLIDER

(76) Inventors: Satoru OOKUBO, Kanagawa (JP); Katsuhide Tanaka, Kanagawa (JP); Masaki Otsuka, Kanagawa (JP); Kiyoshi Hashimoto, Kanagawa (JP)

Correspondence Address: HITACHI C/O WAGNER BLECHER LLP, 123 WESTRIDGE DRIVE, WATSONVILLE, CA, 95076, US

(21) Appl. No.: 12/854,079

(22) Filed: Aug. 10, 2010

(30) Foreign Application Priority Data
Aug. 10, 2009 (JP) 2009-185815

(51) Int. Cl. G11B 5/60

(52) U.S. Cl. 360/235.5; 360/235.4; G9B/5.229

(57) ABSTRACT

A magnetic head slider comprising: an air inflow end; an air bearing surface; and an air outflow end, the air bearing surface comprising: an inflow side rail face further formed towards the air inflow end than the center of the air bearing surface; an outflow side rail face formed further towards the air outflow end than the inflow side rail face, having a magnetic recording/reproduction element arranged thereon; a negative pressure groove face formed between the inflow side rail face and the outflow side rail face; and a groove face formed between the inflow side rail face and the negative pressure groove face, or between the inflow side rail face and the outflow side rail face; and comprising at least one step structure shallower than the groove face at the slider end in the width direction of the groove face.

### CROSS-REFERENCE TO RELATED APPLICATION

This application claims priority from the Japanese Patent Application No. 2009-185815, filed Aug. 10, 2009, the disclosure of which is incorporated herein in its entirety by reference.

### TECHNICAL FIELD

Embodiments of the present technology relate to a magnetic head slider for achieving higher recording densities in a magnetic disk device.

### BACKGROUND

A magnetic disk device comprises: a rotating magnetic disk; a magnetic head slider (hereinafter, termed “slider”) on which the recording/reproduction element is mounted; and a magnetic head support mechanism that is provided with a suspension for supporting the slider; the slider is positionally located in the radial direction of the magnetic disk by means of the magnetic head support mechanism, and the slider reads the magnetic information recorded on the magnetic disk as it travels, relatively, over the magnetic disk. The slider is levitated by the wedge film action of the air acting as an air-lubricated bearing, so that the magnetic disk and the slider do not come into direct solid contact. An effective means of raising the recording density and consequently increasing the capacity of the magnetic disk device or reducing its size is to decrease the distance between the slider and the magnetic disk, i.e. the amount of the slider levitation, thereby increasing the linear recording density. Also effective is to stabilize the change in the amount of levitation of the slider.

As a means of stabilizing the change of the amount of slider levitation, U.S. Patent Application No. 2008/0198509 discloses the rigidity of the air bearing of the slider may be increased by generating a large negative pressure in the vicinity of the air inflow end, by forming a channel groove between the center portion from the vicinity of the air inflow end of the slider air bearing surface towards the direction of the magnetic head and the positive pressure generating pad and negative pressure groove.

### BRIEF DESCRIPTION OF THE DRAWINGS

FIG. 1 is a perspective view of an air bearing surface of a magnetic head slider according to an embodiment of the present technology.

FIG. 2 is a plan view of an air bearing surface of a magnetic head slider according to an embodiment of the present technology.

FIG. 3 is a layout diagram of a magnetic disk device provided with a magnetic head slider according to an embodiment of the present technology.

FIG. 4 is a perspective view of the air bearing surface of a magnetic head slider.

FIG. 5 is a plan view of the air bearing surface of a magnetic head slider.

FIG. 6 is a view showing the relationship with the skew angle of the magnetic head slider in the inner circumferential condition of the magnetic disk.

FIG. 7 is a view showing the relationship with the skew angle of the magnetic head slider in the outer circumferential condition of the magnetic head disk.

FIG. 8 is a view showing the relationship with the skew angle of the magnetic head slider in the inner circumferential condition of the magnetic disk according to an embodiment of the present technology.

FIG. 9 is a view showing the relationship with the skew angle of the magnetic head slider in the outer circumferential condition of the magnetic head disk according to an embodiment of the present technology.

FIG. 10 is a plan view of an air bearing surface of the magnetic head slider according to an embodiment of the present technology.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview

An appreciable amount of dust is present in the casing of the magnetic disk device, resulting from entry of dust during the device manufacturing process and caused by generation of dust from the various members of the device itself. Thus, there is a risk of this dust penetrating into the gap between the slider and the magnetic disk. Penetration of dust into the gap between the slider and the magnetic disk not only affects reliability of the levitation performance of the slider but also risks mechanical damage of the slider and magnetic disk due to entrapment of the dust in the gap between the slider and the magnetic disk.

In order to achieve high reliability of the magnetic disk device, it is extremely important to prevent interference with the recording/reproduction function by the dust present in the device. In order to prevent interference with the recording/reproduction function by the dust present in the device, consideration has been given to reducing the number of dust particles present in the casing of the magnetic disk device and to the reduction of mechanical damage to the magnetic disk device and slider caused by entrapment of dust particles in the gap between the slider and the magnetic disk. Also, in order to reduce mechanical damage caused by entrapment of dust particles, consideration has been given to employment of materials having high durability in respect to the mechanical damage for the slider and the magnetic disk, and to reducing entrapment of dust particles by the improvement in the air bearing face of the slider.

However, it is difficult to completely reduce the number of dust particles present in the casing of the magnetic disk device, and an optimum material for the magnetic head slider and magnetic disk must be selected taking into account not only mechanical durability but also recording/reproduction performance.

Embodiments of the present technology provide a magnetic head slider with an air inflow end, an air bearing surface (ABS) and an air outflow end, the ABS having an inflow side rail face formed further towards the air inflow end than the center of this ABS, an outflow side rail face where a magnetic recording/reproduction element is arranged and formed further towards the air outflow end side than this inflow side rail face, a negative pressure groove face formed between the inflow side rail face and the outflow side rail face; and a groove face formed between the inflow side rail face and the negative pressure groove face, or between the inflow side rail face and the outflow side rail face; the magnetic head slider having one or more step structures that are shallower than this groove face at the end of the groove face in the slider width direction.

In one embodiment, the outflow side rail face has the same height as the inflow side rail face and is further provided with a front step bearing face that is shallower than the inflow side rail face and is formed between the air inflow end and the inflow side rail face and a rear step bearing face that has the same depth as the front step bearing face formed on the air inflow side of the outflow side rail face.

In one embodiment, the magnetic head slider, according to embodiments of the present technology, is constructed as a magnetic head slider provided with an air inflow end, an air outflow end, an ABS formed between the air inflow end and the air outflow end, a front step bearing face formed further at the air inflow end than the center of this ABS, an inflow side rail face that is shallower than the front step bearing face formed at the side of the air inflow end of this front step bearing face, a groove face that is formed further at the air outflow end than this inflow side rail face and that is deeper than the inflow side rail face defining the periphery thereof, a rear step bearing face that is shallower than the groove face formed further at the air outflow end than this groove face, and an outflow side rail face where the magnetic recording/reproduction element is arranged and that is shallower than the rear step bearing face formed at the side of the air outflow end of this rear step bearing face.

In one embodiment, the groove face is a channel groove face and the magnetic head slider is further provided with a side rail face formed further on the outside in the width direction of the ABS than the outflow side rail face, having the same height as the inflow side rail face, and a side step bearing face having the same depth as the front step bearing face, formed on the air inflow side of this side rail face.

Moreover, in one embodiment, the step structure has the same depth as the negative pressure groove face. Additionally, in one embodiment, the step structure has the same depth as the front step bearing face. Also, in one embodiment, the step structure has the same height as the inflow side rail face.

In embodiments of the present technology, the step structure has a protective wall preventing the penetration of dust, so that deterioration of the levitation reliability produced by the penetration of dust and/or diminution of mechanical damage to the magnetic head slider and magnetic disk can be achieved by forming at least one step structure shallower than the channel groove face at the point of contact of the channel groove face and the end in the slider width direction.

### Example Magnetic Head Slider

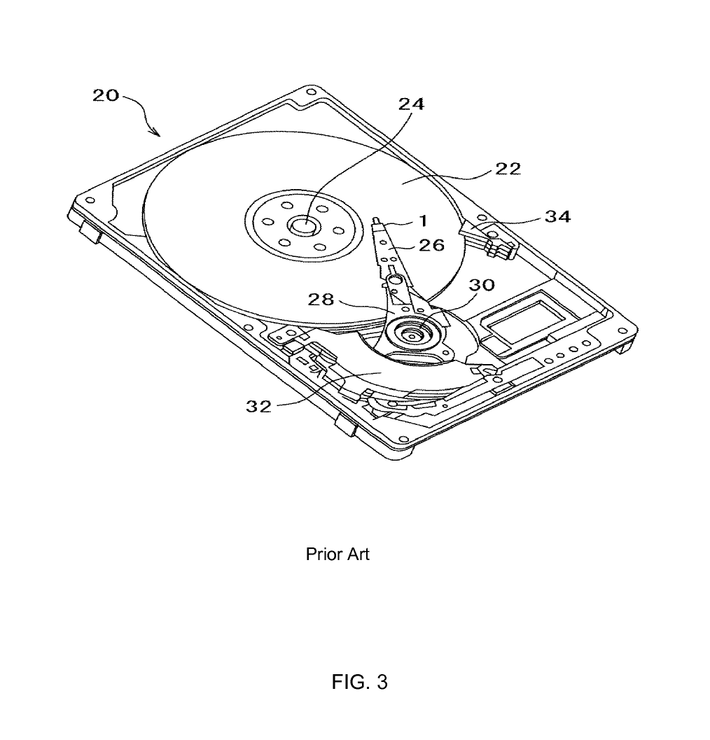

Before describing embodiments of the present technology, a layout diagram of a magnetic disk device in which a magnetic head slider according to the present technology is mounted will be described with reference to FIG. 3.

The magnetic disk device 20 comprises: a magnetic disk 22 that stores the magnetic information; a spindle motor 24 to which the magnetic disk 22 is fixed and whereby this magnetic disk is rotated; a magnetic head slider (hereinafter, termed “slider”) 1 on which a recording/reproduction element is mounted; a magnetic head support mechanism (load beam) 26 provided with a suspension that supports the slider 1; a head arm 28 on which the magnetic head support mechanism 26 is mounted; a bearing unit 30 on which the head arm 28 is mounted; and a voice coil motor 32 that is mounted on the bearing unit 30. The slider 1 is positionally located in the radial direction of the magnetic disk 22 by the magnetic head support mechanism 26 and reads/writes magnetic information recorded on the magnetic disk as the slider 1 travels relatively over the magnetic disk 22. The slider 1 is levitated by the wedge film effect of the air constituting an air lubricated bearing, so that the magnetic disk 22 and the slider 1 are not directly in solid contact. The rear end of the slider 1 that receives this air flow faces the rotating magnetic disk 22 and constitutes the outflow end face of the slider.

In order to achieve increased recording density of the magnetic disk device and increased capacity or miniaturization of the device, it is effective to reduce the distance between the slider 1 and the magnetic disk 22 i.e. the amount of slider levitation, and to raise the linear recording density. In recent years, the amount of slider levitation has been reduced to about 10 nm or less than 10 nm.

The slider 1 is mounted on a plate spring shaped magnetic head support mechanism 26 having a suspension and is subjected to a pressing load onto the magnetic disk face by means of the magnetic head support mechanism 26 and recording/reproduction of the entire magnetic disk face is performed by a seek operation of the slider 1 in the radial direction of the magnetic disk 22 by means of the voice coil motor 32 and the magnetic head support mechanism 26. The slider 1 is retracted onto a ramp 34 from the magnetic disk 22 when the device is stopped or when no read/write instruction is generated for a fixed time.

It should be noted that although, in this case, a device provided with a loading/unloading mechanism has been illustrated, the magnetic disk device could be a device of the contact start/stop type, in which the slider 1 stands by in a specified region of the magnetic disk 22 when the device is stopped.

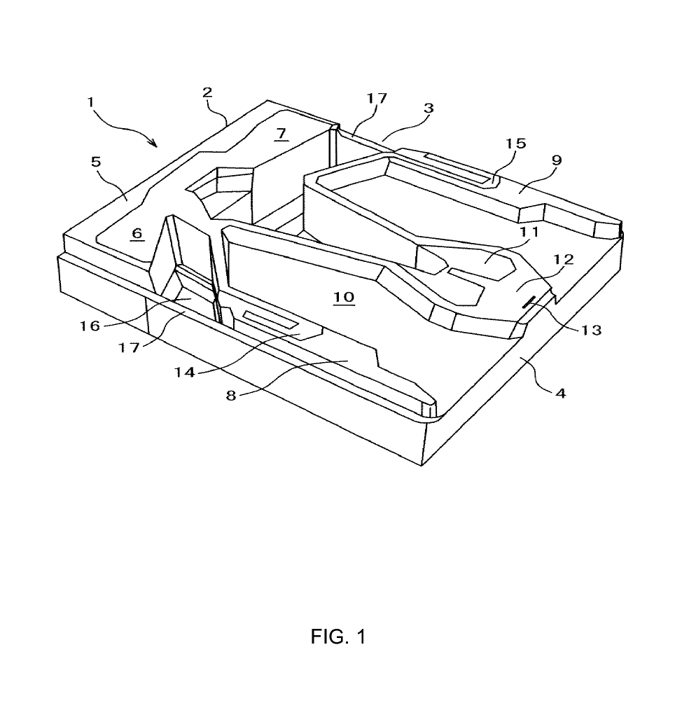

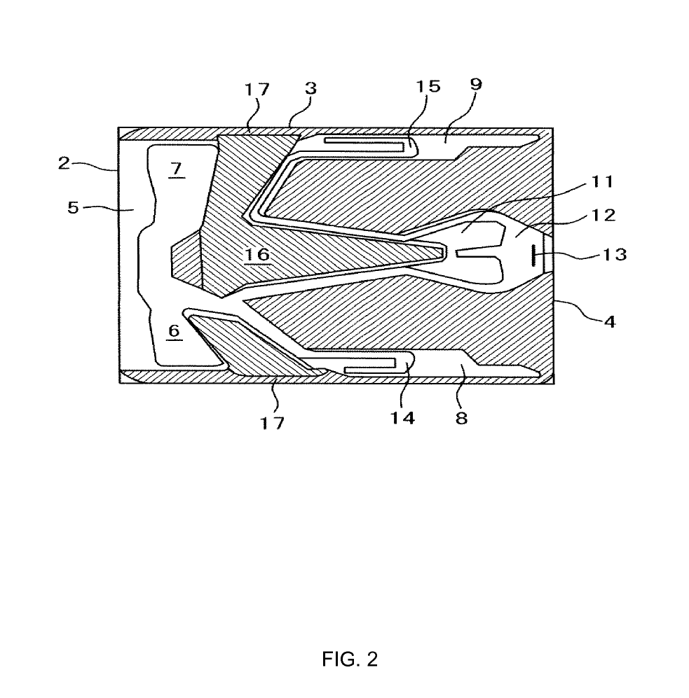

According to embodiments of the present technology, FIG. 1 and FIG. 2 show to a larger scale the construction of the ABS of the magnetic head slider in FIG. 3. FIG. 1 is a perspective view seen from the direction of the ABS and FIG. 2 is a plan view seen from the direction of the ABS. In one embodiment, the slider 1 is constituted of a substrate (wafer) portion of material typified by a sintered body of alumina and titanium carbide (hereinafter, abbreviated as “AlTiC”), and a thin film magnetic head portion. The thin-film magnetic head portion comprises, among other things, a magnetic recording element and magnetic reproduction element 13 and insulating film formed on the substrate by a thin-film process.

In one embodiment, the slider 1 may be, for example, a so-called pico-slider, having a substantially cuboidal shape of length 1.25 mm, width 1.0 mm and thickness 0.3 mm, having a total of six faces: an ABS 3; air inflow end face 2; air outflow end face 4; two side faces; and a rear face. It should be noted that, apart from a pico-slider, a slider according to a so-called “femto-slider” standard, of length 0.85 mm, width 0.7 mm, thickness 0.23 mm, i.e. of smaller size could be employed, with a view to lowering costs and improving the precision of positional location due to mass reduction, or slider of other dimensions.

In one embodiment, on the ABS 3, a fine step (step bearing) is provided, produced by a process such as ion milling or etching. This plays the role of an air bearing for supporting the load borne by the rear face, by generating air pressure facing the disk (not shown).

Further, in one embodiment, the fine step in the ABS 3 substantially comprises four types of parallel faces. These four types comprise, from nearest the disk: inflow side rail faces 6 and 7 provided further on the inflow side than the center of the ABS 3, of substantially the same height as the face where the element is arranged; an outflow side rail face 12 provided further on the outflow side than the center of the ABS 3 and side rail faces 14 and 15 provided further on the outside in the width direction of the ABS 3 than the outflow side rail face 12; a front step bearing face 5 of depth 100 nm to 200 nm from the face where the element is arranged; a rear step bearing face 11 and side step bearing faces 8 and 9; a negative pressure groove face 10 about 1 μm deeper than the face where the element is arranged; and a channel groove face 16 about 2 μm to 5 μm deeper than the face where the element is arranged.

The channel groove face 16 is formed such that it is extending so as to make contact with the end of the slider in the width direction, being formed between the inflow side rail faces 6 and 7, the negative pressure groove face 10 and the outflow side rail face 12. By forming the channel groove face 16 between the negative pressure groove face 10 and inflow side rail faces 6 and 7 constituting positive pressure generating sections, a buffer region is produced where substantially no pressure is generated, between the positive pressure generating section and negative pressure generating section. By means of this buffer region, it is possible to reduce the dependence of the negative pressure generating section on the positive pressure generating section. Due to this effect, even when the pressure generated with respect to changes in the environment changes, stable negative pressure can be generated, making it possible to stabilize changes in the amount of element levitation. Also, by making the channel groove face 16 extend so that it is also connected with the outflow side rail face 12, this channel groove structure promotes air compression and also contributes to efficient pressure generation at the outflow side rail face 12.

At least one or more step structures 17 that are shallower than the channel groove face 16, are formed at the end of the channel groove face 16 in the slider width direction (i.e. at the point of contact of the channel groove face 16 and the end of the slider in the width direction). The depth of the step structures 17 from the place where the element is arranged is the same as the depth of the negative pressure groove face 10. By making this depth of the step structures the same as that of the negative pressure groove face 10, these step structures can be formed at the same time, in the step of forming the negative pressure groove face 10. The step structures 17 perform the action of preventing penetration of dust from the slider width direction end of the channel groove face 16 into the interior of the slider 1, in cases where a skew angle is produced by movement of the slider 1 towards the inner periphery of the disk or towards the outer periphery of the disk.

Next, the air pressure generated at the ABS 3 will be described. When the airflow generated by disk rotation penetrates from the front step bearing face 5 onto the inflow side rail faces 6 and 7 or from the rear step bearing face 11 onto the outflow side rail face 12, it is compressed by the tapered flow path, generating positive air pressure. Also, when the air penetrates from the inflow side rail faces 6 and 7 onto the channel groove face 16, substantially no pressure is generated. In contrast, when the air penetrates to the negative pressure groove face 10 from the inflow side rail faces 6 and 7 present between the channel groove face 16 and negative pressure groove face 10, the outflow side rail face 12 and the rail faces having the same height as the side rail faces 14 and 15, negative air pressure is generated by expansion of the flow path. It should be noted that the groove depth shown in FIG. 1 is exaggerated.

The slider 1 is designed in such a way that it is levitated in an attitude such that the amount of levitation at the side of the air inflow end 2 is larger than the amount of levitation at the side of the air outflow end 4. Consequently, maximum proximity to the disk occurs at the ABS in the vicinity of the outflow end. In the vicinity of the outflow end, the outflow side rail face 12 projects with respect to the surrounding rear step bearing face 11 and negative pressure groove face 10. Thus, so long as the slider pitch attitude and roll attitude do not exceed a fixed limiting inclination, the outflow side rail face 12 is the face that is in closest proximity to the disk. The magnetic recording element and magnetic reproduction element 13 are formed in portions belonging to the thin film head portion of the outflow side rail face 12. The shape of the ABS 3 is designed so that there is an exact balance between the pressing load from the load beam 26 and the positive/negative air pressure generated at the ABS 3, so as to maintain the distance from the magnetic recording elements and magnetic reproduction elements 13 to the magnetic disk 22 at a suitable value of about 10 nm. Also, at least the outflow side rail face 12 is covered with a protective film of, for example, carbon, in order to protect against corrosion of the magnetic recording/reproduction element 13.

It should be noted that, although the inflow side rail faces 6 and 7 and the outflow slide rail face 12 are in contact, in the present specification, for convenience, the outflow side rail face 12 is shown as being further on the outflow side than the channel groove face 16. Also, although the side rail faces 14 and 15 and the outflow side rail face 12 are in contact, the portions on the side step bearing faces 8 and 9 are taken as being the side rail faces 14 and 15 and the side that is more towards the center than these is taken as being the outflow side rail face 12. In some cases, the outflow side rail face 12 that is parallel with the inflow side rail faces 6 and 7 that are linked with the side rail faces 14 and 15 may be referred to as a cross rail face.

Also, although the above description was for the case of a slider whose ABS 3 was constituted with three step bearings formed from four types of substantially parallel faces 16, 10, 11 and 12, in embodiments of the present technology, a slider with four or more step bearings formed of five or more types of parallel faces may also be employed. For example, the side of the inflow side and/or outflow side rail face 12 (cross rail face) further upstream than the rear step bearing face 11, compared with the slide rail faces 14 and 15 of the outflow slide rail face 12, could be made to be a face deeper than the downstream side in comparison with the rear step bearing face 11 of the side rail faces 14 and 15 or outflow side rail face 12.

Furthermore, taking into account the ease of positional alignment when etching, in one embodiment, a face of the same height is provided as the front step bearing face 5 between the inflow side rail faces 6 and 7 and the channel groove face 16.

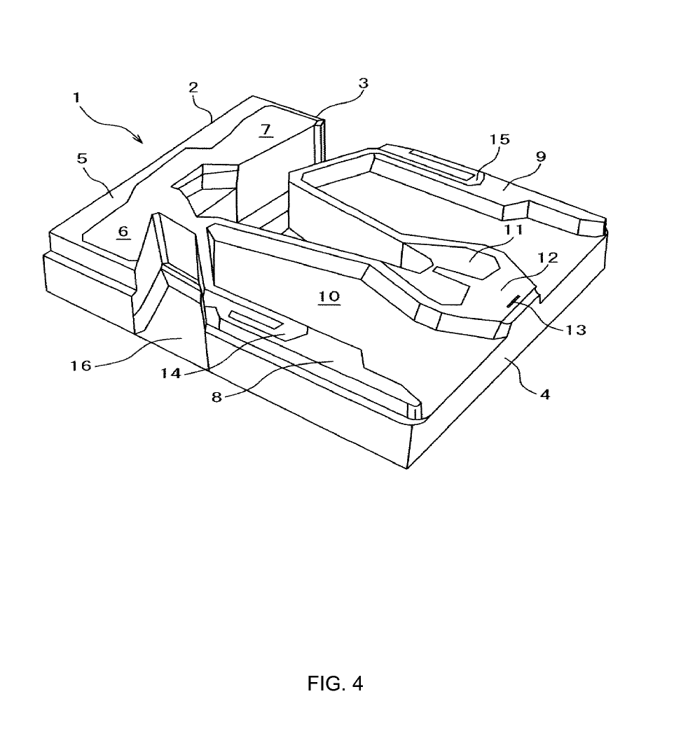

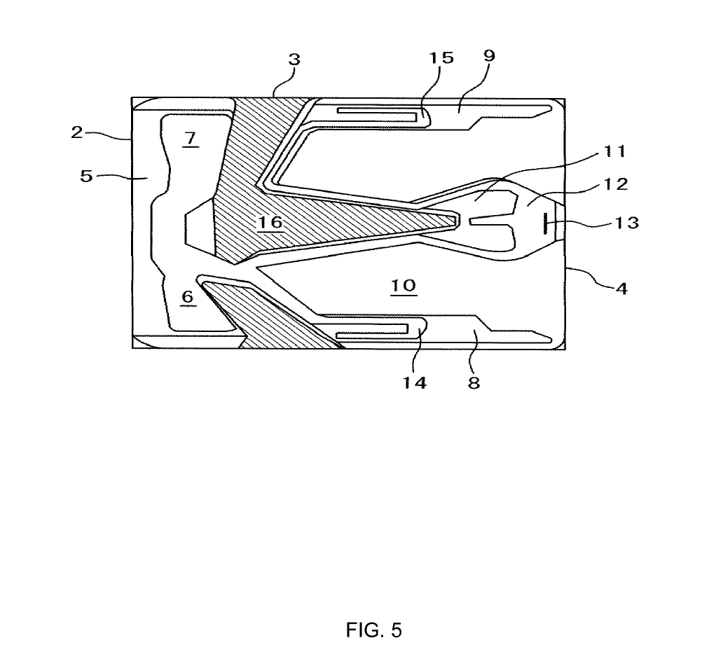

In order to describe the effect of the magnetic head slider 1 according to the embodiments described above in FIGS. 1, 2 and 3, as comparative examples, FIG. 4 and FIG. 5 show a ABS construction in which no step structure 17 is provided on the channel groove face 16. In the operation of the magnetic disk device, in order to perform recording/reproduction over the entire magnetic disk face, the magnetic head slider 1 uses the voice coil motor 32 and a magnetic head support mechanism 26 to perform a seek operation in the radial direction of the magnetic disk 22. The skew angle, which is the angle formed by the magnetic head slider 1 and the tangent of the magnetic disk circumferential direction, changes with change in the disk radial direction position produced by this seek operation.

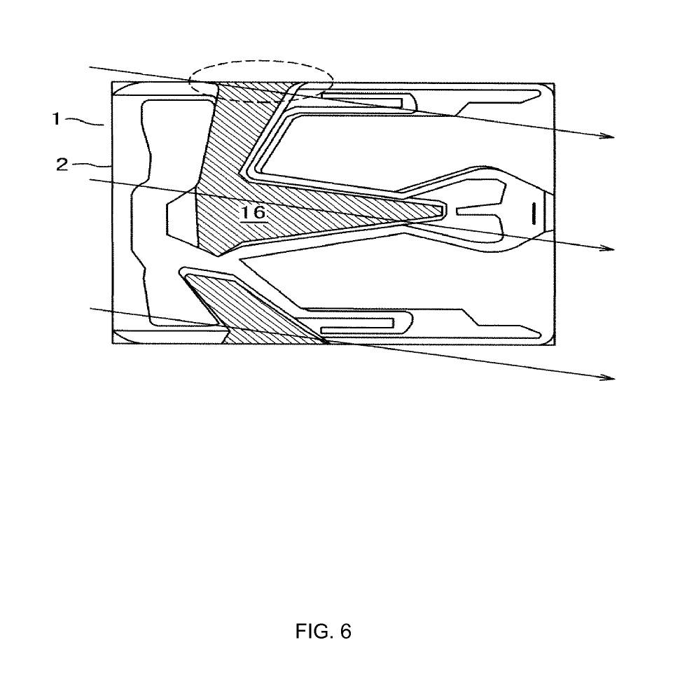

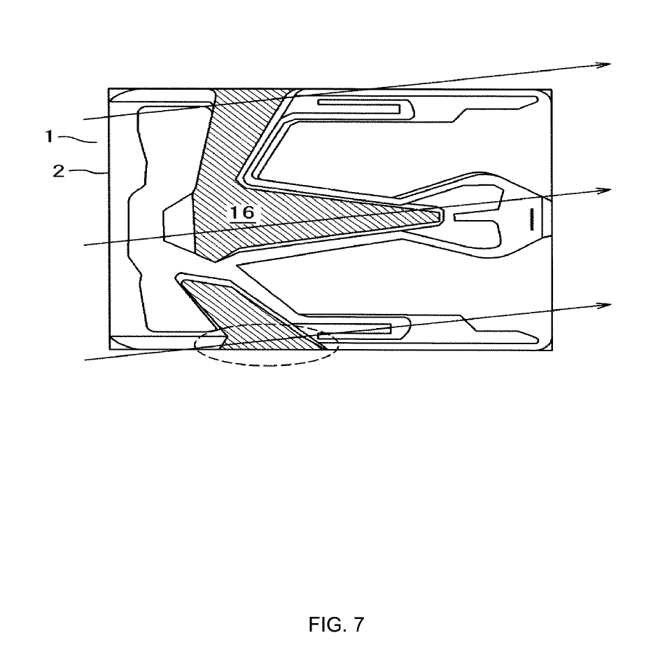

In the ABS structure of the comparative example shown in FIG. 4 and FIG. 5, FIG. 6 shows the positional relationship of the ABS with the skew angle when the magnetic head slider 1 is positioned at the inner circumferential side of the magnetic disk 22. FIG. 7 shows the positional relationship of the ABS with the skew angle when the magnetic head slider 1 is positioned on the outer circumferential side of the magnetic disk 22. In FIG. 6 and FIG. 7, the tangent in the circumferential direction of the magnetic disk is shown by a solid line arrow. In the case of the skew angle condition as shown in FIG. 6 and FIG. 7, the channel groove face 16 connected with the slider end in the width direction constitutes an air inflow port in the region indicated by a broken-line circle in the Figure. Since the channel groove face 16 is deeper by about 2 μm to 5 μm than the face where the element is arranged, there is a possibility that dust having a size of less than about 2 μm to 5 μm may penetrate into the interior of the slider.

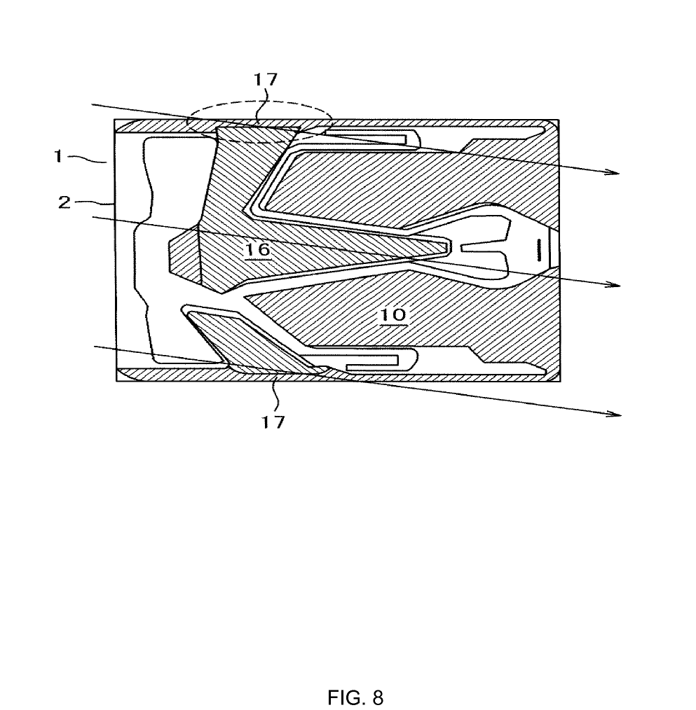

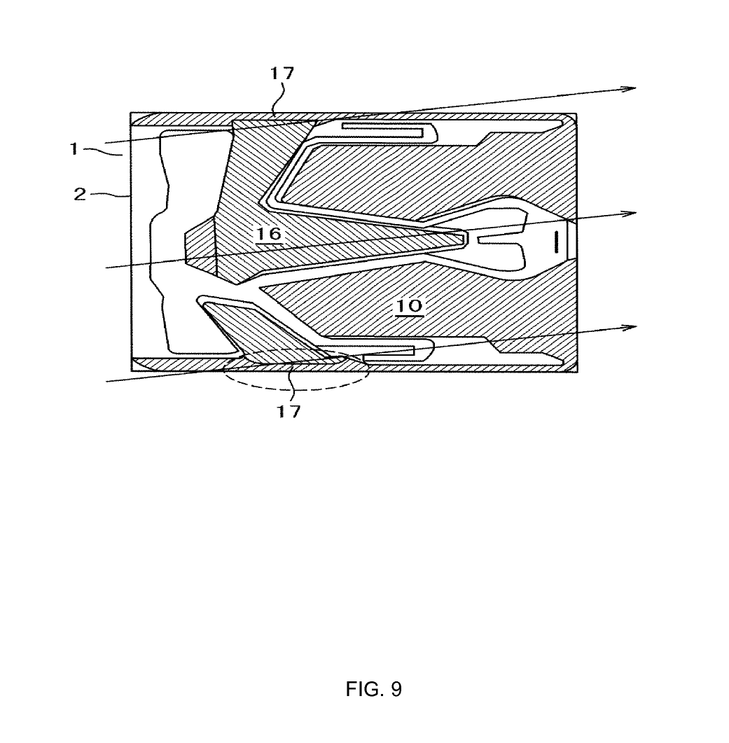

Also, in the case of the ABS construction of the embodiments shown in FIG. 1 and FIG. 2, the positional relationship of the ABS with the skew angle in the case where the magnetic head slider 1 is positioned at the inner circumferential side of the magnetic disk 22 is shown in FIG. 8 and the positional relationship of the ABS with the skew angle in the case where the magnetic head slider 1 is positioned on the outer circumferential side of the magnetic disk 22 is shown in FIG. 9.

In the construction of the ABS of an embodiment, since step structures 17 having the same depth as the negative pressure groove face 10 are formed at the points of connection of the channel groove face 16 and the slider ends in the width direction, the step face having the same depth as the negative pressure groove face 10 constitutes an air inflow port in the region indicated by the broken-line circle in the Figure.

Since this step face is about 1 μm deeper than the face where the element is arranged, dust having a size of at least about 1 μm has little likelihood of penetrating into the slider interior in this region. In other words, by employing the ABS construction of the present embodiment, the gap at the air inflow port is narrowed compared with the ABS construction of the comparative example, so the possibility of penetration of dust larger than the air inflow port into the interior of the slider is low, and the total number of dust particles penetrating into the interior of the slider even in the case of dust of smaller size than the air inflow port can be reduced. Degradation of levitation reliability or mechanical damage to the magnetic disk 22 or the magnetic head slider 1 produced by the penetration of dust can therefore be reduced.

It may be noted that, in embodiment of the present technology, the above ABS construction can easily be formed without increasing the number of processes, by employing a process such as ion milling or etching for the formation of the steps of the ABS 3.

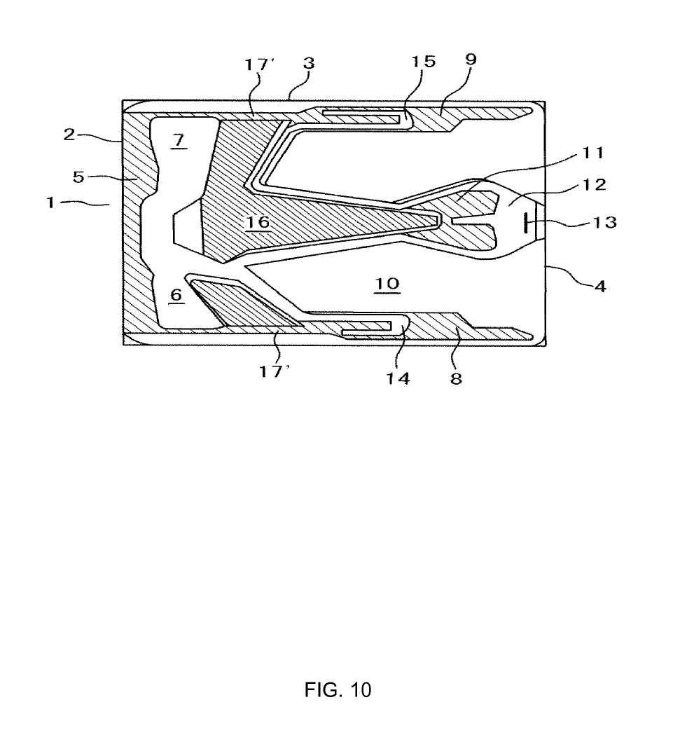

Another embodiment of the present technology is shown in FIG. 10. In the embodiments shown in FIG. 1 and FIG. 2, step structures 17 are formed having the same depth as the negative pressure groove face 10 at the points of connection of the channel groove face 16 and the slider ends in the width direction. In the embodiment shown in FIG. 10, step structures 17 are formed having the same depth as the front step bearing face 5, rear step bearing face 11 and side step bearing faces 8, 9 at the points of connection of the channel groove face 16 and the slider end in the width direction. Since these step faces have a depth of about 100 nm to 200 nm from the face where the element is arranged, dust of size 100 nm to 200 nm or more has little likelihood of penetrating into the interior of the slider in this region. Consequently, by adopting the construction of the embodiment shown in FIG. 10, the gap at the air inflow port can be narrowed, thereby further reducing degradation of the levitation reliability or mechanical damage to the magnetic head slider and magnetic disk produced by penetration of dust.

It should be noted that, although, in embodiments described above, the case was described in which step structures were formed having the same depth as the negative pressure groove face 10 of the front step bearing face 5, rear step bearing face 11 and side step bearing faces 8 and 9 at the points of connection of the channel groove face 16 and the slider ends in the width direction, it would also be possible to adopt step structures having other depths. These adopted step structures could be formed by a combination of processes such as ion milling or etching used to form the step of the ABS 3 or step structures having the same height as the inflow side rail faces 6 and 7, outflow side rail face 12 and side rail faces 14 and 15.

Embodiments of the present technology can be applied to magnetic head sliders adapted for achieving higher recording density in magnetic disk devices.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A magnetic head slider comprising:
an air inflow end;
an air bearing surface; and
an air outflow end, said air bearing surface comprising:
an inflow side rail face further formed towards said air inflow end than the center of said air bearing surface;
an outflow side rail face formed further towards said air outflow end than said inflow side rail face, having a magnetic recording/reproduction element arranged thereon;
a negative pressure groove face formed between said inflow side rail face and said outflow side rail face; and
a groove face formed between said inflow side rail face and said negative pressure groove face, or between said inflow side rail face and said outflow side rail face; and
comprising at least one step structure shallower than said groove face at the slider end in the width direction of said groove face.

2. The magnetic head slider as claimed in claim 1, wherein said groove face is a channel groove face and the magnetic head slider is further provided with a side rail face formed further on an outside in the width direction of said air bearing surface than said outflow side rail face, having a same height as said inflow side rail face, and a side step bearing face having a same depth as said front step bearing face, formed on said air inflow side of said side rail face.

3. The magnetic head slider as claimed in claim 1, wherein said step structure has a same depth as said negative pressure groove face.

4. The magnetic head slider as claimed in any of claims 1, wherein said step structure has a same depth as said front step bearing face.

5. The magnetic head slider as claimed in claim 1, wherein said step structure has a same height as said inflow side rail face.

6. The magnetic head slider as claimed in claim 1, wherein said outflow side rail face has a same height as said inflow side rail face and is further provided with a front step bearing face that is shallower than said inflow side rail face and is formed between said air inflow end and said inflow side rail face and a rear step bearing face that has a same depth as said front step bearing face formed on the air inflow side of said outflow side rail face.

7. The magnetic head slider as claimed in claim 6, wherein said groove face is a channel groove face and the magnetic head slider is further provided with a side rail face formed further on the outside in the width direction of the air bearing surface than said outflow side rail face, having the same height as said inflow side rail face, and a side step bearing face having the same depth as said front step bearing face, formed on the air inflow side of this side rail face.

8. The magnetic head slider as claimed in claim 6, wherein said step structure has a same depth as said negative pressure groove face.

9. The magnetic head slider as claimed in any of claims 6, wherein said step structure has a same depth as said front step bearing face.

10. The magnetic head slider as claimed in claim 6, wherein said step structure has a same height as said inflow side rail face.

11. A magnetic head slider comprising:
an air inflow end;
an air outflow end;
an air bearing surface formed between said air inflow end and said air outflow end;
a front step bearing face formed further at said air inflow end than the center of said air bearing surface;
an inflow side rail face that is shallower than said front step bearing face formed at the side of said air inflow end of said front step bearing face;
a groove face that is formed further at said air outflow end than said inflow side rail face and that is deeper than said inflow side rail face defining the periphery thereof;
a rear step bearing face that is shallower than said groove face formed further at said air outflow end than said groove face; and
an outflow side rail face where the magnetic recording/reproduction element is arranged and that is shallower than said rear step bearing face formed at the side of said air outflow end of said rear step bearing face.

12. The magnetic head slider as claimed in claim 11, wherein said groove face is a channel groove face and the magnetic head slider is further provided with a side rail face formed further on the outside in the width direction of the air bearing surface than said outflow side rail face, having a same height as said inflow side rail face, and a side step bearing face having a same depth as said front step bearing face, formed on the air inflow side of said side rail face.

13. The magnetic head slider as claimed in claim 11, wherein said step structure has a same depth as a negative pressure groove face that is formed between said inflow side rail face and said outflow side rail face.

14. The magnetic head slider as claimed in any of claims 11, wherein said step structure has a same depth as said front step bearing face.

15. The magnetic head slider as claimed in claim 11, wherein said step structure has a same height as said inflow side rail face.

16. The magnetic head slider as claimed in claim 12, wherein said step structure has a same depth as said negative pressure groove face that is formed between said inflow side rail face and said outflow side rail face.

17. The magnetic head slider as claimed in claim 12, wherein said step structure has a same depth as said front step bearing face.

18. The magnetic head slider as claimed in claim 12, wherein said step structure has a same height as said inflow side rail face.

19. The magnetic head slider as claimed in claim 12, further comprising:
a tapered flow path configured for compressing airflow generated by disk rotation, said airflow penetrating from said front step bearing face onto said at least one inflow side rail face or penetrating from said rear step bearing face onto said outflow side rail face, thereby generating positive air pressure.

20. The magnetic head slider as claimed in claim 12, further comprising:
an expanded flow path configured for enabling expansion of airflow generated by disk rotation, said airflow penetrating said negative pressure groove face from at least one said inflow side rail face present between said channel groove face and said negative pressure groove face, thereby generating a negative air pressure.
